(19) United States
(12) Patent Application Publication
(10) Pub. No.: US 2021/0090023 A1
(43) Pub. Date: Mar. 25, 2021

(54) Systems And Methods For Delivery Vehicle Routing In Urban Areas Based On Package Information

(71) Applicant: Ford Global Technologies, LLC, Dearborn, MI (US)

(72) Inventors: Sandeep Sasidharan, Dearborn, MI (US); Harry Christian Martinez, Northville, MI (US)

(73) Assignee: Ford Global Technologies, LLC, Dearborn, MI (US)

(21) Appl. No.: 16/581,121

(22) Filed: Sep. 24, 2019

(51) Int. Cl. G06Q 10/08

(52) U.S. Cl. CPC G06Q 10/08355; G06Q 10/0838

(57) ABSTRACT

Systems and methods are disclosed for computing an optimized delivery route for a delivery vehicle based on package information. Example methods may include receiving a plurality of delivery fulfillment requests from at least one client platform, each delivery fulfillment request including a delivery location, selecting a set of requests from the received delivery fulfillment requests, each request within the set including a delivery location within a same geographical region, assigning the selected set of requests to a delivery vehicle based on capacity information for the delivery vehicle and package information for each package which is to be delivered by the delivery vehicle, computing a preliminary delivery route for the delivery vehicle based on the delivery locations of the delivery fulfillment requests within the selected set, computing an optimized delivery route for the preliminary delivery route based on the package information, and dispatching the optimized delivery route to the delivery vehicle.

### TECHNICAL FIELD

The present disclosure relates generally to delivery vehicle routing and more particularly relates to systems and methods for delivery vehicle routing based on package information.

### BACKGROUND

The rise of e-commerce has created a dramatic increase in last mile deliveries. Last mile deliveries typically refer to the delivery of goods from a transportation hub or depot to a final delivery destination such as a consumer's home. In addition to being a key to customer satisfaction, last mile deliveries are both the most expensive and time-consuming part of the shipping process, due in part to the fact that the final leg of shipment typically involves multiple delivery stops with small and few delivery packages. Hence, efficient vehicle delivery routing plays a critical role in last mile deliveries.

On-demand package delivery business has also become mainstream since the popularity of e-commerce businesses. On-demand delivery platforms leverage thousands of part-time local vehicle delivery operators to bring products to customers immediately or on-demand. In urban areas, this increase in on-demand deliveries, is complicated by traffic congestion. Moreover, in dense urban areas, the on-demand deliveries are further complicated by limited availability of parking for delivery vehicles. Many delivery vehicle operators and delivery personnel lose valuable time trying to find a parking space when traveling from one delivery location to the next delivery location.

While there are presently solutions available for optimizing routing and navigation for delivery, most of these solutions target optimizing the routing based on delivery locations, fuel consumption and time constraints. Thus, it is desirable to provide optimized vehicle delivery routing which includes determining a vehicle parking location which will maximize the number of deliveries the delivery personnel may perform from the parked location without having to move the vehicle.

### BRIEF DESCRIPTION OF THE DRAWINGS

FIG. 1 depicts an illustrative architecture in which techniques and structures for providing the systems and methods disclosed herein may be implemented, according to various embodiments of the disclosure.

FIG. 2 illustrates a diagram of an exemplary set of components for a delivery transportation platform, according to various embodiments of the disclosure.

FIG. 3 depicts an exemplary structure of the content in a package information database, according to various embodiments of the disclosure.

FIG. 4 is a flowchart illustrating by way of example the steps that may be performed to compute a preliminary delivery route for a delivery vehicle, according to various embodiments of the disclosure.

FIG. 5 is a flowchart illustrating by way of example the steps that may be performed to compute an optimized delivery route for a delivery vehicle, according to various embodiments of the disclosure.

FIG. 6 is an exemplary map illustration of a set of delivery locations assigned to a delivery vehicle, according to various embodiments of the disclosure.

FIG. 7 is an exemplary graphical illustration of a parking space identification, according to various embodiments of the disclosure.

### DETAILED DESCRIPTION

### Overview

The systems and methods disclosed herein are configured to optimize a delivery route for a delivery vehicle based on package information of corresponding delivery packages. In some embodiments, the optimized delivery route identifies a best parking space for the delivery vehicle so that the operator of the delivery vehicle may perform deliveries to multiple delivery locations while the delivery vehicle remains parked at the identified best parking space.

In some embodiments, the present disclosures identify walkable delivery locations within a set of deliveries. The walkable delivery locations may be determined by computing the distance between any two of the delivery locations within the set of deliveries assigned to the delivery vehicle. The walking distance computation may be based on any suitable distance metric, such as, for example, a Euclidean distance, a Manhattan distance, etc. The selection of the type of distance metric to be used can be configured or selected by the routing algorithm. The distance may be computed by computing the Euclidean distance or the Manhattan distance or alternatively, the distance may be calculated using the feature of Google maps which determines the walking distance between two locations.

In one example embodiment, the present disclosure can be used to compute an optimized delivery route by modifying a preliminary delivery route which is determined based on the delivery locations of the deliveries within a set of deliveries. The preliminary delivery route is modified by routing the delivery vehicle to a best parking space location within the geographical region of the set of deliveries. The best parking space may be determined by evaluating which of the available parking spaces in the region will provide the highest feasibility of a delivery personnel being able to perform deliveries to multiple locations in the set of delivery requests while the delivery vehicle remains parked at the best parking spot. The evaluation process analyzes the identified walkable delivery locations relative to the size and weight of the delivery packages. The results of the evaluation process are used to compute an optimized delivery route for the delivery vehicle. In other various embodiments, weather information may also be included in the computed optimized delivery route for the delivery vehicle.

### Illustrative Embodiments

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It should be understood that alternate implementations may be used in any combination desired to form additional hybrid implementations of the present disclosure. For example, any of the functionality described with respect to a particular component such as a first processor in a first computer may be performed by another component such as a second processor in another computer. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and terms are used herein solely for convenience and such words and terms should be interpreted as referring to various objects and actions that are generally understood in various forms and equivalencies by persons of ordinary skill in the art. For example, the word “information” as used herein may refer to various items such as digital data, analog data, audio content, and video. It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

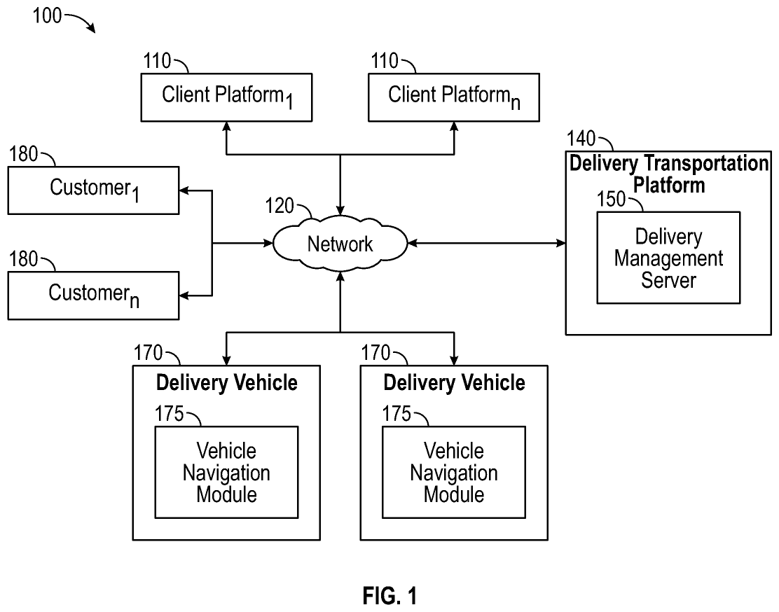

Turning now to the drawings, FIG. 1 depicts an illustrative architecture 100 in which techniques and structures of the present disclosure may be implemented. The illustrative architecture 100 may include one or more client platforms such as client platform 110, a delivery transportation platform 140, one or more delivery vehicles such as delivery vehicle 170, a network 120, and one or more customer platforms such as customer platform 180. Although not shown, the illustrative architecture 100 includes one or more electronic communications channels for transmitting data/control/information between client platforms 110, network 120, delivery vehicles 170 and delivery transportation platform 140.

The network 120 may include any one or a combination of multiple different types of networks, such as, cable networks, the Internet, wireless networks, and other private and/or public networks. In some instances, the network 120 may include cellular, Wi-Fi, or Wi-Fi direct.

In various embodiments, client platform 110 may operate with an e-commerce business which sells goods to consumers 180, such as, for example, Amazon, or Uber EATS. The client platform may provide an interface to consumers to facilitate placement of orders. The consumers may use customer platform 180 to access the interface provided by client platform 180 to purchase goods sold by the e-commerce business. The customer platform 180 may include an application program and a mobile phone, laptop, desktop, tablet or any other Wi-Fi enabled electronic device to interface with client platform 110. Once orders are placed for goods on the client platform, delivery fulfillment requests may be generated by the client platform and sent to delivery transportation platform 140 for processing delivery of the ordered goods. Each delivery fulfillment request may include package information (e.g., item name, size, weight) and delivery instructions (e.g., delivery location and delivery time). The delivery location may include an address, GPS location, or the like.

The client platform 110 may include one or more servers and data storage devices (not shown). The one or more servers may include one or more processors (e.g., microprocessors, graphics processors, coprocessors, etc.), computer readable memory (e.g., read-only memory (ROM), random access memory (RAM)), and mechanisms and structures for performing I/O operations. At least one of the servers may execute an operating system for execution on a central processing unit and one or more application programs to control the operations of the client platform. The data storage devices may store one or more databases, the operating system and one or more application programs.

In various embodiments, the delivery transportation platform (DTP) 140 may operate with a delivery transportation service, which provides resources (e.g., delivery vehicles, vehicle operators and delivery personnel) for delivering packages. The delivery vehicles may include autonomous vehicles and non-autonomous vehicles. The vehicle operators may include humans and non-humans (e.g., computer or robot). The delivery personnel may perform the door to door deliveries and may include humans and non-humans (e.g., a biped or quadrupled robot). In some embodiments, the vehicle operator and the delivery personnel may be one and the same. The DTP may manage the processing of incoming delivery fulfillment requests (i.e. delivery orders) and oversee resources in performing the deliveries in an efficient manner. The deliveries may include last mile deliveries and/or on demand deliveries.

The DTP 140 may include one or more servers such as delivery management server 150. Each server may include mechanisms and structures for performing I/O operations, one or more processors, and one or more computer readable memory, such as, for example, read-only memory (ROM), random access memory (RAM), or any other type of computer readable data storage device. Databases, basic input/output systems (BIOS), operating systems and application programs may be stored in the computer readable memory. The one or more processors may include graphics processors, application processors, coprocessors, digital signal processors and other dedicated processors. The processors may be communicably coupled with the computer readable memory and configured to run the operating systems, user interfaces, application programs (e.g., preliminary router 263 and optimized router 264), and other components.

In various embodiments, the delivery vehicle 170 may include a car, automobile, van, pick-up, bus, truck, scooter or any other motorized structure used for transportation. The delivery vehicle may also include a vehicle navigation module 175, which may be integrated with the vehicle's controls or the vehicle navigation module 175 may be a third-party add-on device. The vehicle navigation module provides directions to the vehicle operator. In another embodiment, a mobile phone navigation tool may be used as the vehicle navigation module. The delivery vehicle receives a set of delivery requests and an optimized delivery route from the delivery transportation platform 140. The vehicle navigation module directs the vehicle operator to the delivery locations in the set of delivery requests. The delivery personnel performs the deliveries in an order consistent with the optimized delivery route.

The delivery vehicle 170 may be owned and operated by individuals who independently contract with the delivery transportation service. In other aspects, the delivery vehicle may be owned and operated by the delivery transportation service. The delivery vehicle may interface with the delivery transportation platform (DTP) 140 through a mobile phone, computerized dashboard or any other suitable Wi-Fi enabled electronic processing device with navigation and a display.

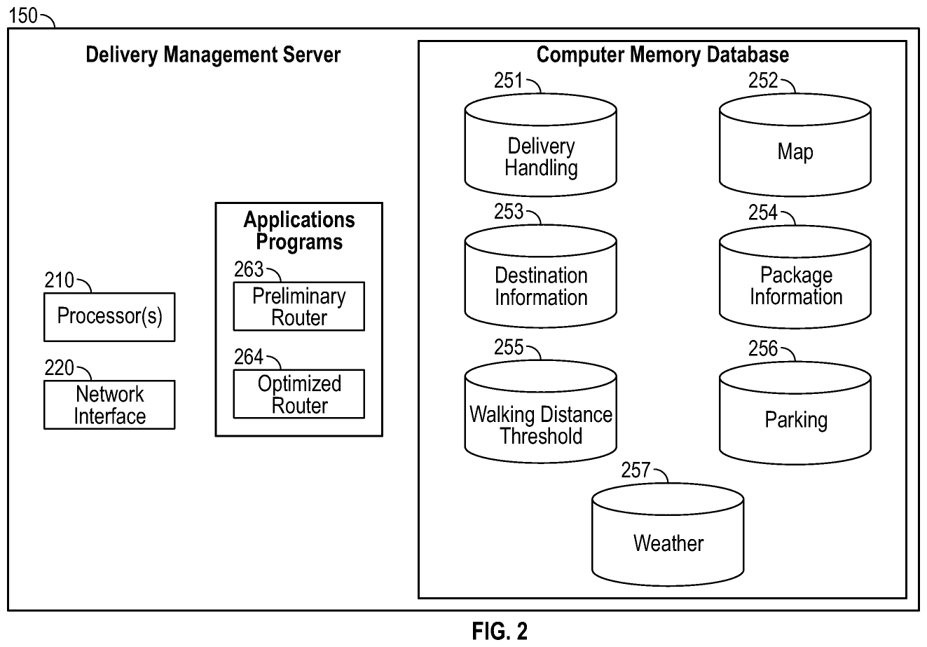

Turning to FIG. 2, a diagram illustrating a set of components for a delivery management server 150 is shown, according to various embodiments of the disclosure. The delivery management server administers the processing of delivery fulfillment requests, which may include receiving and storing incoming delivery fulfillment requests, organizing delivery and package information, creating sets/batches of delivery fulfillment requests, assigning each set of requests to a delivery vehicle, computing a preliminary delivery route for each set of delivery fulfillment requests, optimizing the preliminary delivery route for each set of delivery fulfillment requests and dispatching the set of delivery fulfillment requests and the optimized delivery route to the corresponding assigned delivery vehicle.

The delivery management server 150 may include a plurality of databases for storing information used in the processing of the delivery fulfillment requests. The databases may include, for example, delivery handling database 251, map database 252, destination information database 253, package information database 254, walking distance threshold 255, parking database 256, and weather database 257. The databases may be cloud databases or database servers. Moreover, the databases may be implemented as any suitable database model, such as, for example, a relational database model.

The delivery handling database 251 may store a list of the delivery transportation services' resources (i.e., delivery vehicles, vehicle operators, delivery personnel) and data about the resources, such as, for example, vehicle make, model, and year, vehicle size/storage capacity (i.e., maximum weight or volume that can be handled by the vehicle and/or vehicle operator, and/or delivery personnel). The map database 252 may store spatial information for a geographical area, such as, for example, a city, a state, a town, a locality, etc.

The delivery management server 150 may retrieve the map information from any suitable map source, such as, for example, Google Maps. The destination information database 253 may store the incoming delivery fulfillment requests. The destination information database may be divided and/or organized into regions (e.g., localities) within a geographical area (e.g., cities). The delivery fulfillment requests may be stored in the destination information database 253 in a region corresponding to the delivery location for the delivery request.

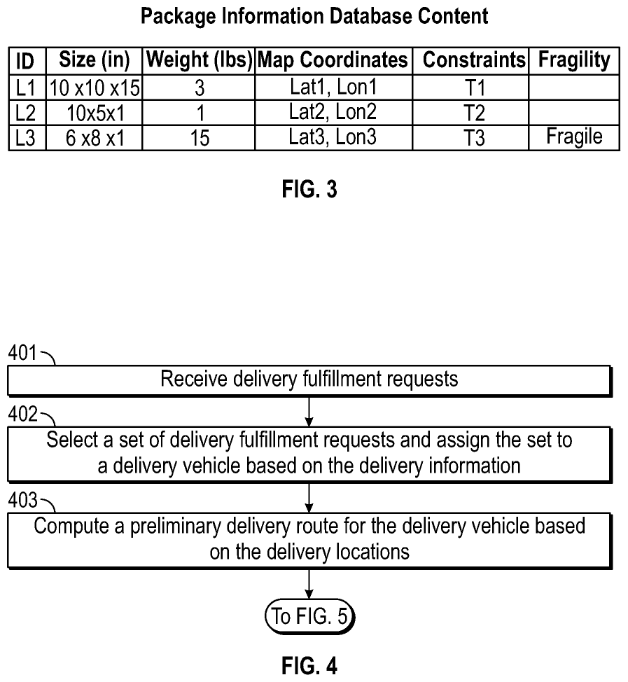

The package information database 254 may store information related to the packages being delivered. As shown in FIG. 3, the package information database may store content information, such as, for example, ID number for the order, size of package, weight of package, map coordinates for the delivery location, delivery constraints, and fragility of the package. The delivery management server 150 may extract the package information from each delivery fulfillment request and store the extracted information in package information database 254.

The walking distance threshold database 255 may store baseline walking distance thresholds. The baseline walking distance thresholds may provide an average range of walking distance for an individual. The average range may be determined by historic data. The baseline walking distance thresholds may include at least one first baseline walking distance threshold which corresponds to an individual walking without carrying any additional weight and a second baseline walking distance threshold which corresponds to an individual walking while carrying additional weight (i.e., transporting one or more items). The second baseline threshold may include a set of thresholds which each provide an average range of walking distance for an individual carrying item(s) of a size within a particular range and of a weight within a particular range. Each baseline threshold in the set may correspond to a different size range and a different weight range. The baseline values may be based on historical data corresponding to healthy adults having the physical capacity to perform deliveries (i.e., able to lift items, carry items and walk with items).

In another aspect, the walking distance threshold database 255 may store baseline walking distance thresholds for a robot.

The parking database 256 may store parking information for regions within a geographical area. The parking information may include parking availability, no parking zones, and loading-unloading parking zones. The parking information may be retrieved from any real-time parking availability system or from historical data. The weather database 257 may store weather information for any geographical area. The weather information may be updated at predetermined time intervals or upon request at any time. The delivery management server 150 may retrieve the weather information from any suitable weather source, such as, for example, the National Weather Service.

The delivery management server 150 may include a plurality of application programs which may be used in the processing of the delivery fulfillment requests. The delivery management server may include one or more processors 210 which are configured to execute the application programs. The application programs may include, for example, preliminary router app 263 and optimized router app 264. Preliminary router is a first stage router that computes a delivery route for a set of delivery fulfillment requests assigned to a delivery vehicle. Optimized router 264 computes an optimized delivery route for the set of the delivery requests.

The delivery management server 150 may include a network interface 220 to transfer data to network 120 and receive data from network 120. Moreover, the delivery management server may transfer delivery fulfillment requests and optimized delivery routes to delivery vehicles 170 via network interface 220, network 120 and at least one electronic communication channel.

In FIG. 4, a flowchart of an example method to compute a preliminary delivery route for a delivery vehicle is shown. The following method is exemplary, and the method is not confined to the actual steps disclosed in FIG. 4. Alternative embodiments may include more or less steps than the steps shown or described herein. The preliminary router 263, contains instructions that when executed by processor 210 cause the processor to perform the steps presented in FIG. 4. At step 401, the processor receives delivery fulfillment requests. The incoming delivery fulfillment requests may be stored in the destination information database 253. The processor may use the map database 252 to determine to which region a delivery location belongs. Thereafter, the processor may store the delivery fulfillment request in a corresponding region of the destination information database.

At step 402, the processor 210 selects a plurality of delivery fulfillment requests to form a set. The selected delivery fulfillment requests in the set may each include a delivery location within a same geographical area. The number of requests selected in a given set depends on the capacity of the delivery vehicle 170 to which the set will be assigned. The delivery handling database 251 stores capacity information for each delivery vehicle. The processor 210 may evaluate the size and weight of the packages corresponding to the delivery fulfillment requests and select a number of requests that a given delivery vehicle is able to accommodate.

At step 403, the processor 210 computes a preliminary delivery route for the set of delivery fulfillment requests assigned to a given delivery vehicle. The preliminary delivery route is computed based on the delivery locations of the delivery fulfillment requests within a set assigned to the given delivery vehicle. Any standard routing algorithm may be used to compute the preliminary delivery route.

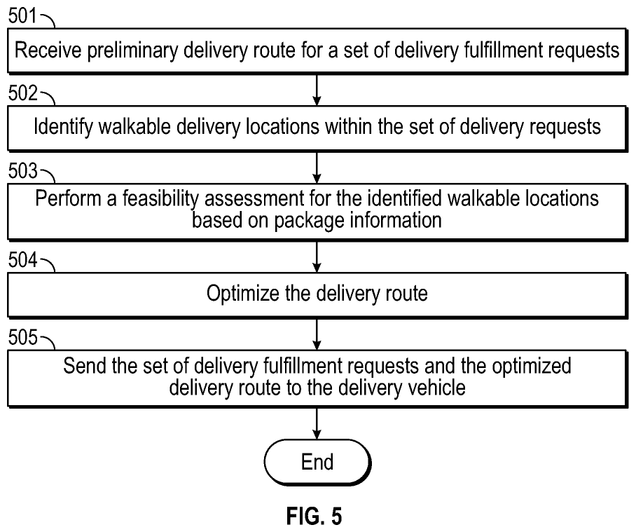

In FIG. 5, a flowchart of an example method to compute an optimized delivery route for a delivery vehicle is shown. The following method is exemplary, and the method is not confined to the actual steps disclosed in FIG. 5. Alternative embodiments may include more or less steps than the steps shown or described herein. The optimized router 264, contains instructions that when executed by processor 210 cause the processor to perform the steps presented in FIG. 5. At step 501, the processor 210 receives the preliminary delivery route for a given delivery vehicle 170.

At step 502, the processor 210 identifies walkable delivery locations within the set of delivery requests. In one aspect, the processor may identify walkable delivery locations by computing the distance between any two delivery locations within the set of delivery requests. The processor may compute the distance between any two delivery locations based on any suitable distance metric, such as, for example, a Euclidean distance or a Manhattan distance. The selection of the type of distance metric to be used may be configured or selected by optimized router 264. In another aspect, the processor 210 may determine walkable delivery locations within the set of delivery requests based on the walking distance between any two delivery locations with the set of the delivery requests, which may be determined using Google Maps. The processor 210 may compare the computed distance between the two delivery locations or the determined walking distance between the two delivery locations with a corresponding baseline walking distance threshold in walking distance threshold database 255. The baseline walking distance threshold may be used to evaluate whether the distance between any two delivery locations is walkable.

At step 503, if two or more delivery locations are identified as walkable, the processor 210 may perform a feasibility assessment by determining whether it is feasible for the delivery personnel to perform the deliveries to the identified walkable delivery locations based on the package information for the packages being delivered. More specifically, the processor evaluates the size and weight of the packages being delivered and assesses whether it is feasible for the delivery personnel to carry the packages the distance required to make the deliveries by walking. The processor 210 may use a corresponding baseline walking distance threshold in walking distance threshold database 255 in the feasibility assessment.

In other embodiments, weather information and fragility of the package information may also be considered in determining the feasibility of performing deliveries by walking to any delivery locations identified as walkable. Weather conditions, such as, for example, rain, snow, or ice may affect whether an individual is able to make deliveries by walking and if delivery by walking is still possible despite the weather, the walkable distance of the delivery personnel may nonetheless be affected by the bad weather conditions. Moreover, the fragility (i.e., easy to break) of a package may also be considered in determining the feasibility of delivery by walking for a plurality of packages. To ensure the safe (i.e., undamaged) delivery of a fragile package, it may be necessary to minimize the number of additional packages carried by the delivery personnel.

At step 504, the processor optimizes the delivery route for a set of delivery fulfillment requests. The optimization of the delivery route focuses on achieving the goal of allowing a delivery personnel to perform deliveries to multiple delivery locations within the set of delivery requests while the delivery vehicle remains parked at a parking space. The processor identifies an optimal (i.e., best) parking space for the delivery vehicle to achieve the goal by evaluating the feasibility assessment, the package weight/package size and the identified walkable locations. As noted, a lot of time is lost in performing deliveries to dense urban areas while searching for temporary parking spaces and having to re-park the delivery vehicle at a new parking space for each delivery location. As such, the disclosed delivery route optimization will improve the efficiency of the delivery performance by reducing/quashing the time lost to parking and re-parking the delivery vehicle.

At step 505, the processor 210 dispatches (i.e., sends) the set of delivery fulfillment requests and the optimized delivery route to the delivery vehicle 170.

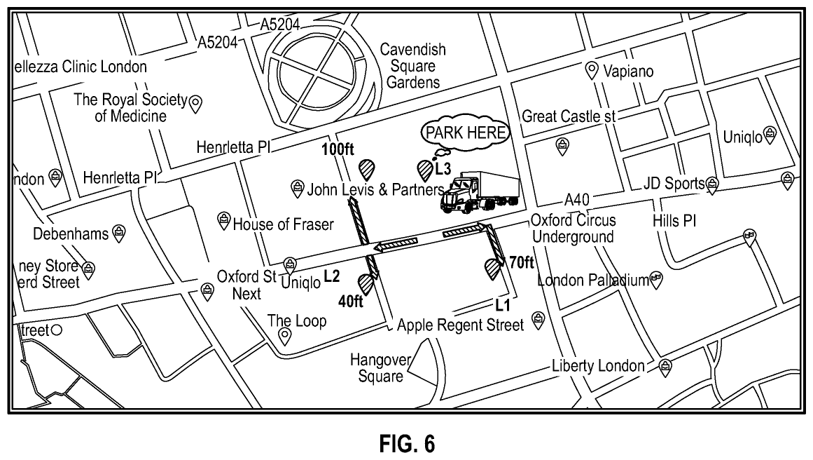

The deliveries to the multiple locations in a set of delivery fulfillment requests may take place multimodal. A vehicle operator may drive the delivery vehicle 170 to a first delivery location and park the delivery vehicle at the first location so that the delivery personnel may perform the delivery to the first delivery location, and thereafter, at least two of the remaining deliveries in the set may be delivered by the delivery personnel by walking while the delivery vehicle remains parked at the first delivery location. By way of example, in FIG. 6, if delivery locations L1, L2 and L3 have all been identified as walkable locations, and the delivery size of L1 is 3 lbs., L2 is 1 lb. and L3 is 15 lbs., then the optimized router may suggest driving to L3, parking at L3 and then walking to deliveries L1 and L2. The optimized router will identify that the package weight to delivery L3 is much heavier (i.e., 15 lbs.) than the package weight for deliveries L1 and L2, and therefore, the best route is for the vehicle operator to drive to the delivery location having the heaviest delivery package weight and then the delivery personnel may walk to the remaining delivery locations to perform the deliveries.

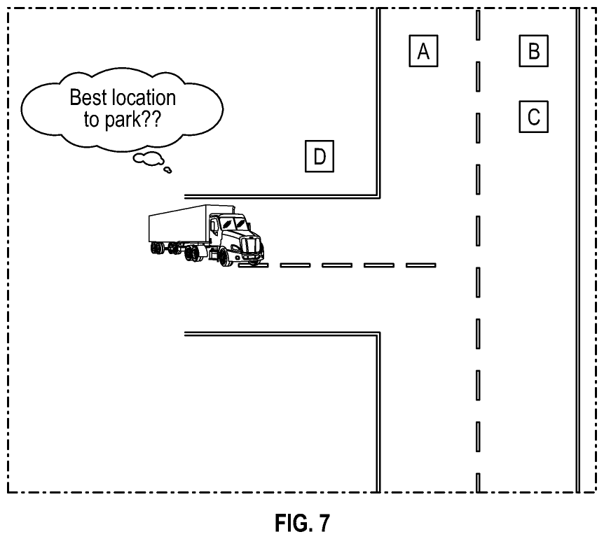

In another aspect, the delivery vehicle may be parked at a parking space location in the same region as the delivery locations in the set and all of the deliveries may be performed by walking while the delivery vehicle remains parked at the parking space locations. By way of example, in FIG. 7, if delivery locations A, B, C and D have been identified as walkable locations, and the package weight of A is 2 lbs., B is 3 lbs., C is 1 lb. and D is 2 lbs., and a parking location P1 is available within the same region as A, B, C and D, then the optimized router may first route the vehicle operator to drive to the location of parking space P1 to park the car. Thereafter, the optimized route may direct the delivery personnel to make the deliveries by walking to delivery location A, then to B, then to C and then to D.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description but is not intended to be exhaustive or to limit the scope of embodiments to the precise form disclosed. Modifications and variations are possible in light of the above teachings or may be acquired from practice of various embodiments.

What is claimed is:

1. A method, comprising:
receiving a plurality of delivery fulfillment requests from a client platform, wherein each delivery fulfillment request includes a delivery location;
selecting a set of requests from the received delivery fulfillment requests, wherein each request within the set includes a delivery location within a same geographical area;
assigning the selected set of delivery requests to a delivery vehicle based on capacity information for the delivery vehicle and package information for each package which is to be delivered by the delivery vehicle;
computing a preliminary delivery route for the delivery vehicle based on the delivery locations of the delivery fulfillment requests within the selected set;
computing an optimized delivery route for the preliminary delivery route based on the package information; and
dispatching the optimized delivery route to the delivery vehicle.

2. The method according to claim 1, further comprising identifying walkable delivery locations within the selected set of delivery fulfillment requests.

3. The method according to claim 2, further comprising computing an optimized delivery route for the delivery vehicle by modifying the preliminary delivery route based on the package information and the identified walkable delivery locations.

4. The method according to claim 2, wherein delivery locations within the selected set of delivery fulfillment requests are identified as walkable based on a computed distance between any two of the delivery locations.

5. The method according to claim 2, wherein delivery locations within the selected set of delivery fulfillment requests are identified as walkable based on a walking distance between any two of the delivery locations.

6. The method according to claim 1, wherein the optimized delivery route identifies a best parking space for the delivery vehicle.

7. The method according to claim 6, wherein the best parking space allows an operator of the delivery vehicle to perform deliveries to multiple delivery locations while the delivery vehicle remains parked at the best parking space.

8. The method according to claim 1, wherein the package information includes a size and a weight of a corresponding package.

9. A method, comprising:
computing a preliminary delivery route for a delivery vehicle based on delivery location information for each delivery within a set of delivery fulfillment requests assigned to the delivery vehicle;
computing an optimized delivery route for the delivery vehicle by modifying the preliminary delivery route based on an optimal parking space for the delivery vehicle, wherein the optimal parking space is determined based on package information for each delivery within the set and walkable delivery locations; and
dispatching the optimized delivery route to the delivery vehicle.

10. The method according to claim 9, wherein the optimal parking space allows a delivery personnel to make deliveries to multiple delivery locations while the delivery vehicle remains parked at the optimal parking space.

11. The method according to claim 9, wherein the walkable delivery locations are determined based on a computed distance between any two delivery locations within the set assigned to the delivery vehicle.

12. The method according to claim 9, wherein the walkable delivery locations are determined based on a walking distance between any two delivery locations within the set assigned to the delivery vehicle.

13. The method according to claim 9, wherein the package information includes a size and a weight for a corresponding package.

14. A system, comprising;
a database for storing package information for a set of delivery fulfillment requests;
a processor;
a memory for storing executable instructions, the processor configured to execute the instructions to:
compute a preliminary delivery route for a delivery vehicle based on delivery location information for each delivery fulfillment requests within the set;
compute an optimized delivery route for the delivery vehicle based on the package information;
and
an electronic communication channel for dispatching the optimized delivery route to the delivery vehicle.

15. The system according to claim 14, wherein the optimized delivery route identifies a best parking space for the delivery vehicle.

16. The system according to claim 15, wherein the best parking space for the delivery vehicle is determined based on the package information for the set of delivery fulfillment requests and walkable delivery locations.

17. The system according to claim 15, wherein the best parking space allows a delivery personnel to make deliveries to multiple delivery locations without moving the delivery vehicle from an optimal parking space.

18. The system according to claim 16, wherein the walkable delivery locations are determined based on a computed distance between any two delivery locations within the set of delivery fulfillment requests.

19. The system according to claim 16, wherein the walkable delivery locations are determined based on a walking distance between any two delivery locations within the set of delivery fulfillment requests.

20. The system according to claim 14, wherein the package information includes a size and a weight for a corresponding package.
